(19) United States
(12) Patent Application Publication
(10) Pub. No.: US 2023/0176883 A1
(43) Pub. Date: Jun. 8, 2023

(54) SEMICONDUCTOR DEVICE AND HARDWARE VIRTUALIZATION METHOD

(71) Applicant: RENESAS ELECTRONICS CORPORATION, Tokyo (JP)

(72) Inventors: Ryuichi IGARASHI, Tokyo (JP); Kenichi TAKEDA, Tokyo (JP); Katsushige MATSUBARA, Tokyo (JP); Tetsuya SHIBAYAMA, Tokyo (JP)

(21) Appl. No.: 17/938,475

(22) Filed: Oct. 6, 2022

(30) Foreign Application Priority Data
Dec. 8, 2021 (JP) 2021-199247

(51) Int. Cl. G06F 9/455; G06F 9/4401

(52) U.S. Cl. CPC G06F 9/45541; G06F 9/4406

(57) ABSTRACT

According to one embodiment, a semiconductor device restricts an OS capable of using a functional block by an OS identifier written in an attribute register for restricting an accessible OS, and creates operation setting values of a first input unit, a second input unit, and a screen synthesis unit per OS to describe them in a setting value list stored in a shared memory, and each of the first input unit, second input unit, and screen synthesis unit has a mask circuit that refers to the OS identifier of the attribute register and in which write of the operation setting values into the setting register group of an own block is hampered, the operation setting values being described in the setting value list created by an OS other than the OS having a use authority for the own block.

### CROSS-REFERENCE TO RELATED APPLICATIONS

The present application claims priority from Japanese Patent Application No. 2021-199247 filed on Dec. 8, 2021, the content of which is hereby incorporated by reference to this application.

### BACKGROUND

The present invention relates to a semiconductor device and a hardware virtualization method, for example, a semiconductor device and a hardware virtualization method in which an operation unit is shared by a plurality of OSs.

In a semiconductor device that performs various processings based on a program(s), there is a hardware virtualization method of performing the processings while a range of hardware used in a plurality of OSs (Operating Systems) is switched. In such a semiconductor device, a memory protecting mechanism needs to prevent memory spaces used among a plurality of programs from interfering with one another. Thus, one example of the memory protecting mechanism is disclosed in Patent Document 1 (Japanese Patent Application Laid-open No. 2017-211980).

The semiconductor device disclosed in Patent Document 1 has a sub-operation unit that executes some processings of a program executed by a main operation unit, and a shared memory that is shared by the main operation unit and the sub-operation unit. Then, it further has a memory protecting unit that permits or denies an access to the shared memory caused by the processing executed by the sub-operation unit based on an access permission range address value given from the main operation unit.

Further, in the semiconductor device disclosed in Patent Document 1, the main operation unit executes a trusted program with high reliability and an untrusted program with lower reliability than the trusted program as programs, and a processing of storing the access permission range address value is executed by the trusted program.

### SUMMARY

However, in the semiconductor device disclosed in Patent Document 1, a switching processing must be executed by the trusted program in switching a memory protecting range, which causes a problem of delay in the switching processing.

The other problems and novel features will be apparent from the description of the present specification and the applying drawings.

According to one embodiment, a semiconductor device and a hardware virtualization method: restrict an OS capable of using a functional block by an OS identifier written in an attribute register for restricting an accessible OS; and create operation setting values of a first input unit, a second input unit, and a screen synthesis unit per OS to describe them in a setting value list stored in a shared memory, and each of the first input unit, second input unit, and screen synthesis unit has a mask circuit that refers to the OS identifier of the attribute register and in which write of the operation setting values into the setting register group of an own block is hampered, the operation setting values being described in the setting value list created by an OS other than the OS having a use authority for the own block.

According to the one embodiment, the semiconductor device and the hardware virtualization method can shorten a time required for the switching processing of a hardware utilizing range.

### BRIEF DESCRIPTION OF THE DRAWINGS

FIG. 1 is a block diagram of a semiconductor device according to a first embodiment.

FIG. 2 is a block diagram for explaining a relationship between a mask circuit and a register of the semiconductor device according to the first embodiment.

FIG. 3 is a diagram for explaining a first example of screen switching in the semiconductor device according to the first embodiment.

FIG. 4 is a diagram for explaining a second example of screen switching in the semiconductor device according to the first embodiment.

FIG. 5 is a block diagram of a semiconductor device according to a second embodiment.

FIG. 6 is a block diagram for explaining a relationship between a mask circuit and a register of the semiconductor device according to the second embodiment.

### DETAILED DESCRIPTION

For clarity of explanation, the following descriptions and drawings are omitted and simplified as appropriate. Moreover, in the respective drawings, the same elements are denoted by the same reference numerals, and an overlapping description will be omitted as necessary.

A semiconductor device described in the following embodiments is hardware shared by a plurality of OSs (Operating Systems), and a hardware virtualization technique that switches a hardware resource(s) allocated to each OS is applied. Specifically, the semiconductor device includes a setting register group in which operation setting values are stored, and has a plurality of functional blocks that operate according to the operation setting values, and an attribute register for storing an OS identifier, which indicates a type of OS having use authorities of the plurality of functional blocks, for each functional block. Then, the operation setting values used in the semiconductor device are described in a setting value list that is created for each OS and is stored in the shared memory shared by the plurality of OSs. In addition, the plurality of functional blocks refer to the OS identifier of the attribute register, and each have a mask circuit for hampering write of the operation setting values into the setting register group of the own block, the operation setting values being described in the setting value list that is created by the OS other than the OS having the a use authority for the own block.

In the following description, as one example of a semiconductor device, a display device that synthesizes screen data generated by a plurality of OSs and changes the screen data synthesized by such a synthesis processing according to a situation will be described. Incidentally, the display device may be implemented as a display IP (Intellectual Property) that is incorporated as part of an operation unit executing a program. Also, the display device uses a shared memory shared by the plurality of OSs, and a system including the display device and the shared memory is called a display system.

### First Embodiment

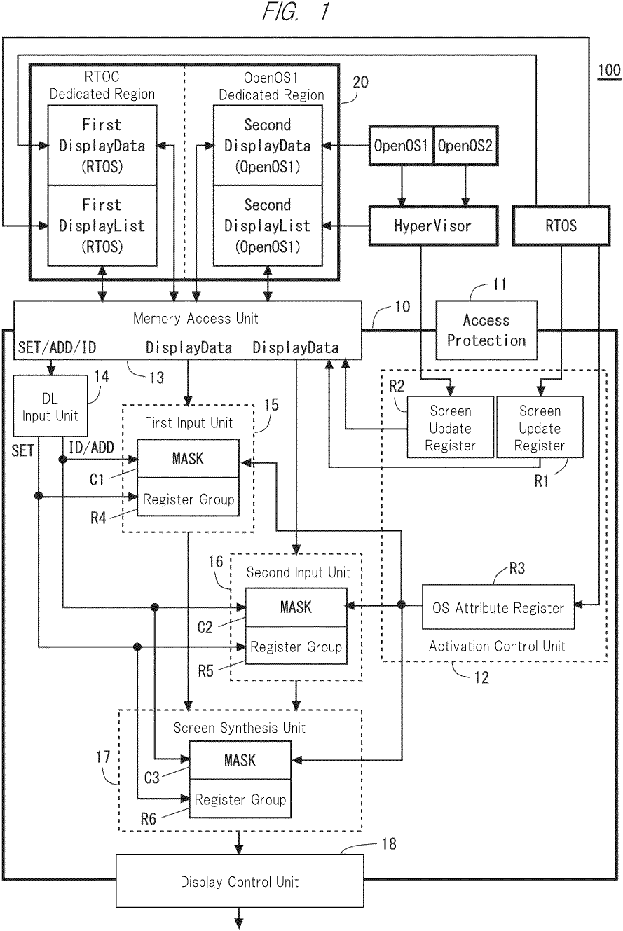

First, FIG. 1 shows a block diagram of a semiconductor device according to a first embodiment. In FIG. 1, part of a display system 100 includes a display device 10, which is a semiconductor device. Also, in the display system 100, a shared memory 20 is shown as a semiconductor device independent of the display device 10. The display device 10 and the shared memory 20 may be accommodated in one package, or may be formed on one semiconductor chip.

In addition, in the display system 100 shown in FIG. 1, a main OS (for example, RTOS (Real Time OS)) and sub-OSs (for example, OpenOS1 and OpenOS2) are shown as operating systems (hereinafter referred to as OSs) that share the display device 10. The RTOS is, for example, an OS in which high-level safety is guaranteed by high-level operation verification, and generates a functional safety screen that provides safety functions to a user of the display system 100. Meanwhile, the OpenOS1 and OpenOS2 correspond to, for example, OSs made as open sources, OSs whose commercial licenses are open to the public, or the like. Further, the OpenOS 1 and OpenOS2 are configured to access the display device 10 via a hypervisor that mediates a processing between the OSs. Incidentally, the number of OSs applied to the display device 10 is not limited to two, and may have only to be at least one.

The display device 10 synthesizes images generated by the RTOS, OpenOS1, and OpenOS2 and displays them on a display (not shown). At this time, in the display system 100, the plurality of OSs need to set operation setting values, which are related to image synthesis, in registers within the display device 10. In addition, a virtualization technique is required in order for one display device 10 to read images generated by the plurality of OSs. Incidentally, in the display system 100, the RTOS handles (is in charge of): generation of a high-importance screen related to functional safety such as a back camera and a warning message; and display control about how to synthesize images, and the OpenOS 1 and OpenOS2 generate screens not related to security such as a navigation screen and an entertainment screen. Details of the display device 10 will be described later.

The shared memory 20 is a memory shared by the RTOS, OpenOS1, and OpenOS2. Then, the shared memory 20 has a plurality of dedicated regions in which access-permitted OSs are restricted. In an example shown in FIG. 1, a ROTS dedicated region and an OpenOS 1 dedicated region are shown as dedicated regions set in the shared memory 20. Incidentally, an OpenOS2 dedicated region is also set in the shared memory 20, but is omitted from the drawing. The ROTS dedicated region is a memory region in which the accessible OS is restricted to the RTOS. The OpenOS1 dedicated region is a memory region in which the accessible OS is restricted to the OpenOS 1. Those dedicated regions are set by a secure processor (not shown) when the display device 10 is activated. That is, data in the RTOS dedicated region and data in the OpenOS1 dedicated region are prevented from interfering with the OS(s) other than the OSs that have mutually generated the data.

Also, a first operation setting value list (for example, first display list) and first screen data (for example, first display data) are stored in the RTOS dedicated region by the RTOS. A second operation setting value list (for example, second display list) and second screen data (for example, second display data) are stored in the OpenOS1 dedicated region by the OpenOS1.

The display list has, as one element, a register address ADD in the display device 10 and an operation setting value SET stored in a resistor designated by that address, and makes a list of a plurality of elements. The display device 10 becomes a master to read the display list from the shared memory 20, and writes the operation setting value SET, which is stored in the data field, into the register having the register address ADD indicated by an address field for each element.

The display data is an image or video data generated by the RTOS and OpenOS 1. This display data may include a video or the like of the back camera.

Here, the display device 10 will be described in detail. As shown in FIG. 1, the display device 10 includes an access protection unit 11, an activation control unit 12, a memory access unit 13, a DL input unit 14, a first input unit 15, a second input unit 16, and a screen synthesis unit 17, and a display control unit 18. In the display device 10, the first input unit 15, the second input unit 16, the screen synthesis unit 17, and the display control unit 18 are functional blocks that perform specific processings, and the other processing blocks can also be regarded as control blocks for controlling behaviors of the functional blocks.

The access protection unit 11 sets a permission authority for each OS in the registers within the display device 10 based on a protection range setting value set by the secure processor in activating the display system 100, and prevents each OS from accessing the registers other than the registers having the permission authority.

The activation control unit 12 has a first screen update register (for example, screen update register R1), a second screen update register (for example, screen update register R2), and an attribute register (for example, OS attribute register R3). In the example shown in FIG. 1, the access protection unit 11 allows only the RTOS to access the screen update register R1 and the OS attribute register R3, and allows only the OpenOS1 and OpenOS2 to access the screen update register R2. An address indicating a storage location of the first display list is stored in the screen update register R1 by the RTOS. An address indicating a storage location of the second display list is stored in the screen update register R2 by the OpenOS1. Further, a size value indicating a size of the first display list is stored in the screen update register R1, and a size value indicating the size of the second display list is stored in the screen update register R2. The size value indicating the size of this display list can also be included in a header of the display list, and when the size values are described in the headers of the display lists, the size values are not stored in the screen update registers R1, R2. The OS identifiers that indicate types of OSs having use authorities of the first input unit 15, the second input unit 16, and the screen synthesis unit 17 are stored in the OS attribute register R3 for each functional block by the RTOS. Those OS identifiers are, for example, ID1 for the RTOS, ID2 for the OpenOS1, and ID3 for the OpenOS2.

In response to at least one of the screen update register R1, the screen update register R2, and the OS attribute register R3 being updated, the activation control unit 12 uses the addresses and the size values stored in the screen update register R1 and the screen update register R2 to issue a read request in which the memory access unit 13 reads the display list from the shared memory 20.

The memory access unit 13 relates an operation setting value, which is included in the display list read in response to an access request received from the activation control unit 12, to a read OS identifier (for example, read ID) indicating the OS corresponding to the screen update register in which address information contained in the access request is stored, and transmits it to the first input unit 15, the second input unit 16, and the screen synthesis unit 17. Incidentally, the memory access unit 13 transfers the operation setting value to the setting register having the address value of the setting register associated with the operation setting value. Incidentally, the memory access unit 13 automatically generates a read ID based on which register the screen update register to be an issuer of the access request is.

Also, the memory access unit 13 reads screen data from the shared memory 20 according to the access requests from the first input unit 15 and the second input unit 16. Then, the function block that is an originator of the access request.

The DL input unit 14 receives, from the memory access unit 13, information related to the display list among the information read from the shared memory 20 by the memory access unit 13, and a read ID associated with the read information, and transmits them to the first input unit 15, the second input unit 16, and the screen synthesis unit 17.

The first input unit 15 has a mask circuit C1 and a setting register group R4. Operation setting values transferred from the DL input unit 14 are stored in the setting register group R4. Also, the mask circuit C1 refers to the OS identifier of the OS attribute register R3, and hampers write of the operation setting values into the setting register group R4 of the own block, the operation setting values being described in the display list that is created by the OS other than the OS having the use authority for the own block.

Then, the first input unit 15 requests the screen data to the shared memory 20 based on the operation setting values stored in the setting register group R4 and transfers, to the screen synthesis unit 17, the screen data read in response to the above-mentioned request. Here, the operation setting values stored in the setting register group R4 include, for example, a plurality of pieces of information related to screen data such as a screen data save destination address, a screen data format, a resolution, and a screen size.

The second input unit 16 has a mask circuit C2 and a setting register group R5. The operation setting values transferred from the DL input unit 14 are stored in the setting register group R5. Also, the mask circuit C2 refers to the OS identifier of the OS attribute register R3, and hampers the write of the operation setting values into in the setting register group R5 of the own block, the operation setting values being described in the display list created by the OS other than the OS having the use authority for the own block.

Then, the second input unit 16 requests the screen data to the shared memory 20 based on the operation setting values stored in the setting register group R5 and transfers, to the screen synthesis unit 17, the screen data read out in response to the request. Here, the operation setting value stored in the setting register group R5 includes, for example, a plurality of pieces of information related to screen data such as screen data save destination addresses, a screen data format, a resolution, and a screen size.

The screen synthesis unit 17 has a mask circuit C3 and a setting register group R6. The operation setting values transferred from the DL input unit 14 are stored in the setting register group R6. Further, the mask circuit C3 refers to the OS identifier of the OS attribute register R3, and hampers the write of the operation setting values into the setting register group R6 of the own block, the operation setting values being described in the display list created by the OS other than the OS having the use authority for the own block.

Then, the screen synthesis unit 17 performs a synthesis processing to the screen data, which is read by the first input unit 15 and the second input unit 16 based on the operation setting values stored in the setting register group R6, according to the operation setting values and generates output screen data. Here, the operation setting values stored in the setting register group R6 include, for example, a plurality of pieces of information related to the output screen data such as: screen configuration information on how any of images in the output screen data to be generated is arranged; a format of the image data; a resolution; and a screen size.

The display control unit 18 displays, on a display (not shown), a screen based on the output screen data generated by the screen synthesis unit 17.

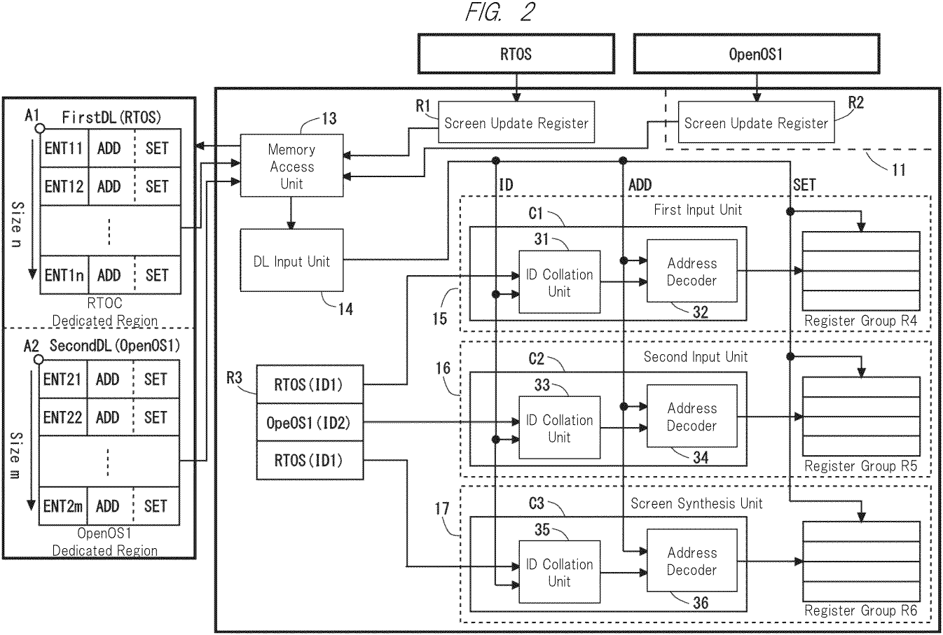

The display device 10 according to the first embodiment has, as one feature, each configuration of the mask circuit, the screen update registers R1, R2, and the OS attribute register R3. Thus, FIG. 2 shows a block diagram for explaining a relationship between the mask circuit and the register of the semiconductor device according to the first embodiment.

As shown in FIG. 2, a setting register address ADD and an operation setting value SET are described in the display list of the shared memory 20 for each entry. In an example shown in FIG. 2, the first display list generated by the RTOS is stored at an address A1 and is configured by n entries ENT11 to ENT1n. Further, the second display list generated by the OpenOS1 is stored at an address A2 and is configured by m entries ENT21 to ENT2m.

In addition, as shown in FIG. 2, the mask circuit C1 of the first input unit 15 has an ID collation unit 31 and an address decoder 32. Also, the mask circuit C2 of the second input unit 16 has an ID collation unit 33 and an address decoder 34. The mask circuit C3 of the screen synthesis unit 17 has an address decoder 36 and an address decoder 36. Here, the ID collation units 31, 33, 35 are all functionally the same. Also, the address decoders 32, 34, 36 are all functionally the same.

A collation unit (for example, an ID collation unit) checks whether the read ID matches the OS identifier corresponding to the own block among the OS identifiers (for example, ID1, ID2) stored in the OS attribute register R3. The address decoder decodes the setting register address ADD sent from the DL input unit 14 and makes the setting register specified in the display list a write-enabled state. Here, the address decoder executes a decoding processing only when determining that the read ID transmitted from the DL input unit 14 matches the OS identifier stored in the OS attribute register R3 for the own block in the corresponding ID collation unit. That is, when the collation unit determines that the read ID matches the OS identifier corresponding to the own block stored in the OS attribute register R3, the mask circuit allows rewriting of the operation setting value into the setting register group of the own block.

In the example shown in FIG. 2, the use authorities of the first input unit 15 and the screen synthesis unit 17 are set to the RTOS. Consequently, write other than the write of the operation setting value SET described in the first display list is hampered in the setting register group R4 of the first input unit 15 and the setting register group R6 of the screen synthesis unit 17. Further, the use authority of the second input unit 16 is set to the OpenOS 1, and write other than the write of the operation setting value SET described in the second display list is hampered in the setting register group R5 of the second input unit 16.

Also, when any one of the screen update register R1, the screen update register R2, and the OS attribute register R3 is rewritten, the activation control unit 12 rewrites the setting register group R4 to the setting register group R5. At this time, the activation control unit 12 does not change access authorities to the screen update register R1, the screen update register R2, and the OS attribute register R3.

Thus, one example of a screen update processing performed by the OpenOS1 will be described below. When the OpenOS1 updates the screen, the screen update processing is performed through the following four steps. (Step S1) The OpenOS 1 writes, into the second display list via the hypervisor, operation setting values to be applied after updating the screen. (Step S2) The OpenOS 1 rewrites the address and size value of the screen update register R2 in order to read the rewritten second display list. At this time, since the OpenOS1 is given the access authority to the screen update register R2, the OpenOS1 accesses the screen update register R2 without intervening the processing of the RTOS. (Step S3) In response to the rewriting of the screen update register R2, the activation control unit 12, memory access unit 13, and DL input unit 14 operate, and the OS attribute is rewritten to the operation setting values after the screen update in the setting register group R5 of the second input unit 16 set in the OpenOS1 16. (Step S4) The activation control unit 12 notifies the OpenOS1 of a current status by interrupt notification.

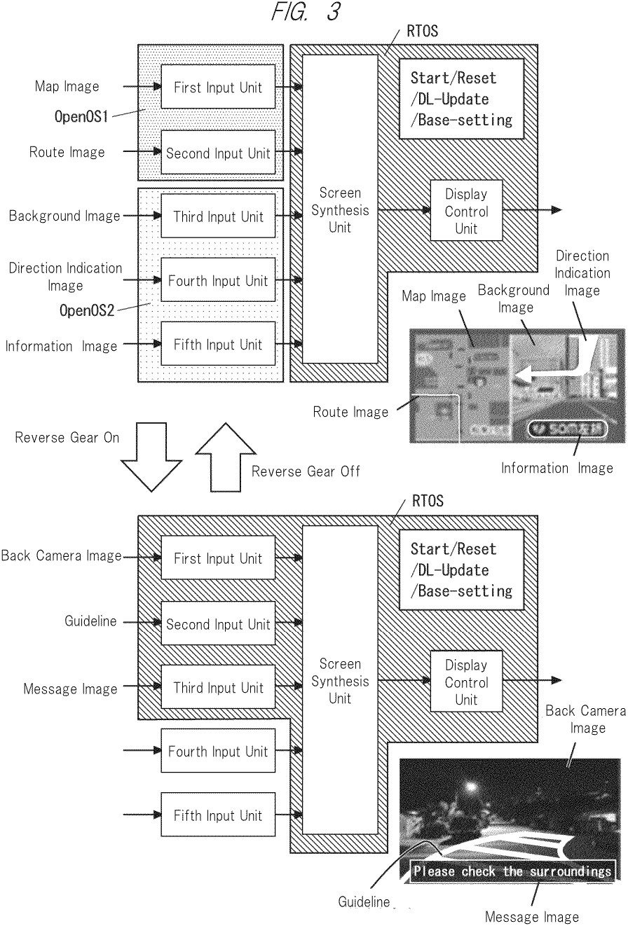

Also, in the display device 10, hardware allocation to the OS is changed due to the hardware virtualization. In the display device 10, communication between the OSs can be reduced even in changing a use resource range in this way. Thus, FIG. 3 shows a diagram for explaining a first example of screen switching in the semiconductor device according to the first embodiment.

An example shown in FIG. 3 shows a state in which a reverse gear of a vehicle is switched on and off while a navigation screen is displayed by the OpenOS1 and OpenOS2. Also, the example shown in FIG. 3 has, as input units, five input units of the first input unit to a fifth input unit.

When the reverse gear is switched off, the display system 100 gives the OpenOS1 the use authorities of the first input unit and the second input unit, gives the OpenOS2 the use authorities of the third input unit to the fifth input unit, and gives the RTOS the use authority of the screen synthesis unit. This is realized by the RTOS giving the OS attribute register R3 of the activation control unit 12 such an OS identifier to become the use authority like this. Then, screen data for the left half screen is generated by the OpenOS 1, and screen data for the right half screen is generated by the OpenOS2.

In the example shown in FIG. 3, the OpenOS1 generates a background image and a route image, respectively, and gives them the screen synthesis unit via the first input unit and the second input unit. Also, the OpenOS2 generates a background image, a direction instruction image, and an information image, and gives them the screen synthesis unit via the third input unit, fourth input unit, and fifth input unit.

Then, when the reverse gear is switched on, in the display system 100 the RTOS rewrites the OS attribute register R3 and the use authorities of the first input unit, the second input unit, the third input unit, and the screen synthesis unit are switched to the RTOS. In addition, the use authorities for the fourth input unit and the fifth input unit are not set, and they are in a stopped state.

When the reverse gear is in an on-state, the RTOS provides a rear camera image as an input to the first input unit, and generates a guideline indicating a planned route of the vehicle and a message image that gives a driver a warning. The guideline is then given to the second input unit, and the message image is given to the third input unit.

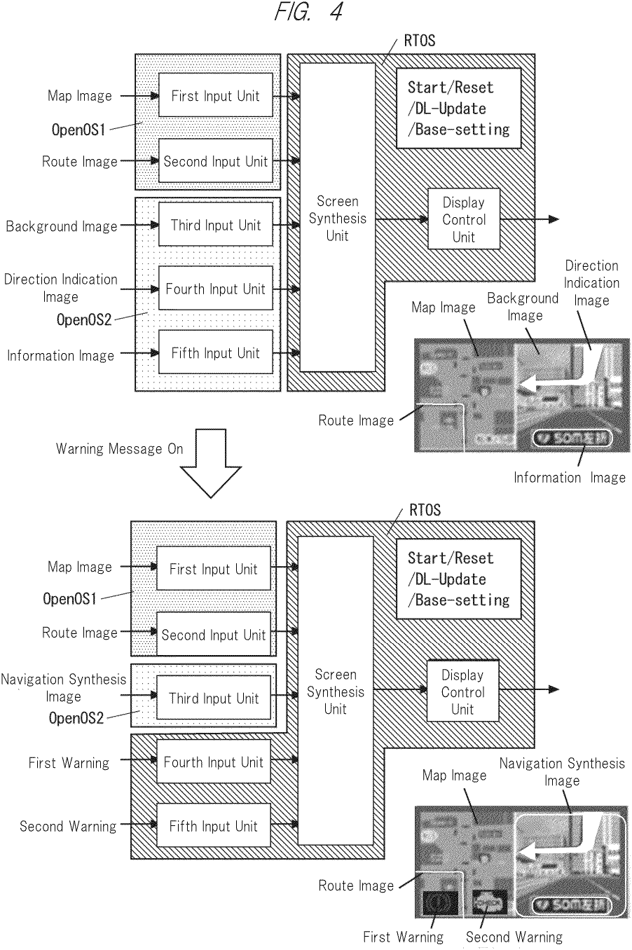

Further, FIG. 4 shows a diagram for explaining a second example of the screen switching in the semiconductor device according to the first embodiment. An example shown in FIG. 4 is an example in which a warning display relating to functional safety is overlaid on a navigation screen while the navigation screen is being displayed by the OpenOS1 and OpenOS2.

A state in which no warning display is shown in FIG. 4 is the same as a case in which the reverse gear is switched off in FIG. 3. Then, when such a status as to determine that the warning display is necessary arises in the RTOS, the display system 100 causes the RTOS to rewrites the OS attribute register R3 and to change the use authorities of the fourth input unit and the fifth input unit from the OpenOS2 to the RTOS. In response to the OS attribute register R3 being rewritten, the activation control unit 12 performs an interrupt notification to the OpenOS2 about the use authority of the function block having been changed. Consequently, the OpenOS2 switches, as screen data to be given to the third input unit, a processing so as to generate a background image, a direction indication image, and an information screen as one navigation synthesis image. Also, in the example shown in FIG. 4, the RTOS generates a first warning image and gives it to the fourth input unit, and generates a second warning image and gives it to the fifth input unit.

As described above, even when the display device 10 according to the first embodiment is used for the plurality of OSs by the access protection unit 11, it prevents interference of operations between the OSs by limiting the access authority to the registers in the display device 10 for each OS. Further, in the display system 100, the operation setting values of the functional blocks are stored as a display list in a region provided exclusively for each OS, and are read in the display device 10 by the addresses stored in the screen update registers R1, R2 whose access authorities are restricted in the display device 10. Consequently, in the display system 100, interference of the processing between the OSs is prevented. In other words, in an environment where the plurality of OSs coexist, the display device 10 can flexibly switch allocation of hardware resources while preventing interference with mutual operations between the OSs in a hardware manner.

The RTOS is a trusted program whose safety is ensured by a very high level of operation verification. Meanwhile, the OpenOS has a lower verification level than that of the RTOS and can be regarded as an untrusted program. Therefore, there are many times when the version of the OpenOS is changed. In such an environment where the RTOS and the OpenOS coexist, when communication between the RTOS and the OpenOS occurs, the operation of the RTOS also needs to be re-verified according to the change of the version of the OpenOS. At this time, in the re-verification of the RTOS, the high-level verification is required for such re-verification, which increases burdens of time and cost. However, in the display system 100 using the display device 10, the communication between the OSs does not occur, so that even if the OpenOS is changed, the RTOS does not need to be re-verified, which can drastically reduce the burdens of time and cost required for the re-verification.

In addition, in the display device 10 according to the first embodiment, when OS operation setting values are changed, the communication between the OSs and the register accessed by each OS do not need to be changed, so that the processings required for changing the operation setting values can be speeded up.

Further, using the display device 10 according to the first embodiment makes it possible to perform the display related to the functional safety by the RTOS that has undergone high-level verification without being disturbed by the OpenOS verified only at a level lower than that of the RTOS.

### Second Embodiment

In a second embodiment, described will be a display system 200 including a display device 10a which is an embodiment different from the display device 10 according to the first embodiment. Incidentally, in a description of a second embodiment, the same components as the components of the first embodiment are denoted by the same reference numerals, and a description thereof will be omitted.

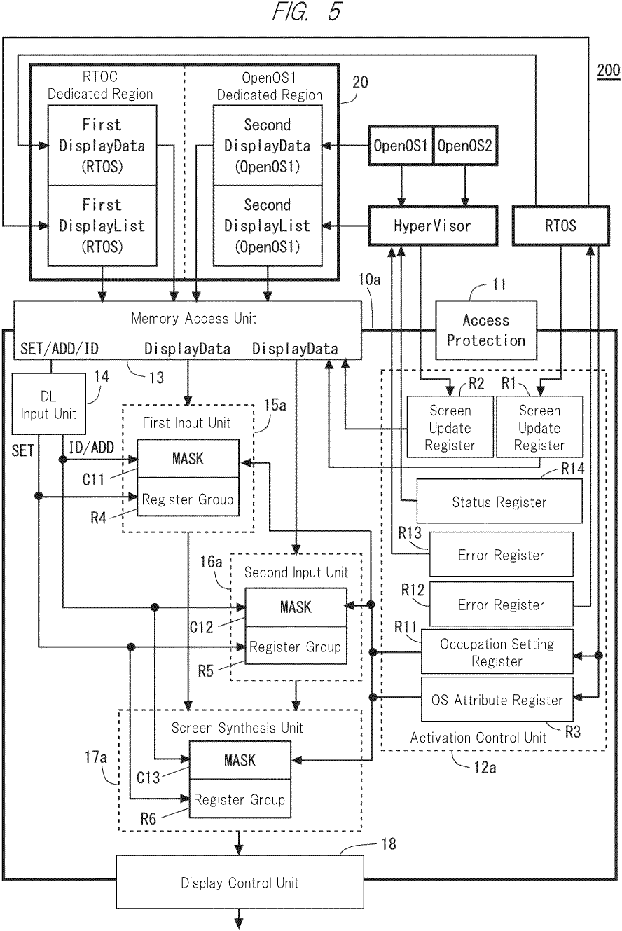

FIG. 5 shows a block diagram of a display system 200 including the display device 10a according to the second embodiment. As shown in FIG. 5, the display device 10a includes an activation control unit 12a, a first input unit 15a, a second input unit 16a, and a screen synthesis unit 17a instead of the activation control unit 12, the first input unit 15, the second input unit 16, and the screen synthesis unit 17 of the display device 10.

The activation control unit 12a is obtained by adding an occupation setting register R11, error registers R12, R13, and a status register R14 to the activation control unit 12. The occupation setting register R11 and the error register R12 are registers whose access authorities are given only to the RTOS. The error register R13 and the status register R14 are registers whose access authorities are given only to the OpenOS (for example, OpenOS1).

The first input unit 15a is obtained by replacing the mask circuit C1 of the first input unit 15 with a mask circuit C11. The second input unit 16a replaces the mask circuit C2 of the second input unit 16 with a mask circuit C12. The screen synthesis unit 17a replaces the mask circuit C3 of the screen synthesis unit 17 with a mask circuit C13.

The display device 10a according to the second embodiment has the activation control unit 12a, the first input unit 15a, the second input unit 16a, and the screen synthesis unit 17a, so that debugging characteristics of the application executed on each OS can be enhanced. Therefore, each functional block of the activation control unit 12a, the first input unit 15a, the second input unit 16a, and the screen synthesis unit 17a will be described in detail.

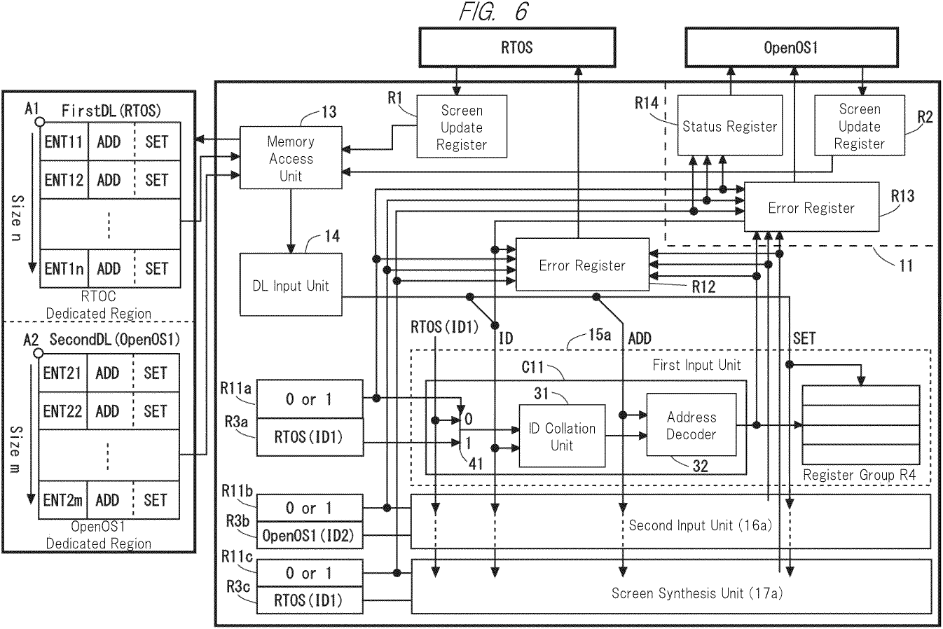

Thus, FIG. 6 shows a block diagram for explaining a relationship between the mask circuit and the register of the semiconductor device according to the second embodiment. Since the mask circuits C11 to C13 have the same configuration, an example shown in FIG. 6 shows a mask circuit of only the first input unit 15a among the first input unit 15a, the second input unit 16a, and the screen synthesis unit 17a. Further, in FIG. 6, it is assumed that a symbol of the OS attribute register R3 corresponding to the first input unit 15a is R3a, a symbol of the occupation setting register R11 is R11a, a symbol of the OS attribute register R3 corresponding to the second input unit 16a is R3b, and a symbol of the occupation setting register R11 is R11b. It is also assumed that a symbol of the OS attribute register R3 corresponding to the screen synthesis unit 17a is R3c, and a symbol of the occupation setting register R11 is R11c.

As shown in FIG. 6, the mask circuit C11 is obtained by adding a selector 41 to the mask circuit C1. Further, a value stored in the occupation setting register R11 is an occupation flag value that serves as a selection signal for the selector 41. This occupation flag value indicates whether to use a value stored in the OS attribute register R3a as the OS identifier given to the collation unit (for example, the ID collation unit 31) or a preset fixed value (for example, the ID1 indicating the RTOS). The occupation flag value is stored for each functional block in the occupation setting register R11. Then, the selector 41 switches the OS identifier given to the ID matching unit 31 between the value stored in the OS attribute register R3a and a fixed value (for example, the ID1 indicating the RTOS) according to the occupation flag value. In an example shown in FIG. 6, if the occupation flag value is 0, the fixed value is given to the ID collation unit 31 and if the occupation flag value is 1, the value of the OS attribute register R3a is given to the ID collation unit 31. Incidentally, it is assumed that the occupation flag value is switched for each functional block according to an instruction from the RTOS.

The status register R14 monitors and holds the occupation flag value stored in the occupation setting register R11. The error registers R12, R13 holds a value obtained by monitoring the occupation flag value, the read ID inputted to the ID collation unit 31 in the mask circuit, the register address (for example, the output value of the address decoder) designating the register included in the setting register group.

In the display system 200 according to the second embodiment, monitoring an input / output of the mask circuit by using the error registers R12, R13 and the status register R14 makes it possible to enhance debugging characteristics of software. In addition, storing the occupation flag value in the occupation setting register R11 make it possible to temporarily change the use authority of the functional block from the RTOS, which can further enhance the debugging characteristics.

As described above, the invention made by the present inventors has been specifically described based on the embodiments, but the present invention is not limited to the embodiments and, needless to say, can variously be modified within a range not departing from the scope thereof.

What is claimed is:

1. A semiconductor device comprising:
a first input unit and a second input unit including a setting register group for storing operation setting values, and reading screen data from a shared memory shared by a plurality of OSs according to the operation setting values;
a screen synthesis unit including the setting register group for storing the operation setting values, performing a synthesis processing to the screen data read by the first input unit and the second input unit according to the operation setting values, and generating output screen data; and
an attribute register storing an OS identifier indicating a type of OS having use authorities of the first input unit, the second input unit, and the screen synthesis unit for each functional block,
wherein the operation setting values for the first input unit, the second input unit, and the screen synthesis unit are created for each OS, and described in a setting value list stored in the shared memory, and
wherein each of the first input unit, the second input unit, and the screen synthesis unit has a mask circuit that refers to the OS identifier in the attribute register and in which write of the operation setting values into the setting register group of its own block is hampered, the operation setting values being described in the setting value list created by an OS other than the OS having a use authority for the own block.

2. The semiconductor device according to claim 1, further comprising:
a first screen update register restricting an access from an OS other than a main OS that handles generation of a functional safety screen among the plurality of OSs, and storing first address information on an address of a first setting value list created by the main OS out of the setting value list; and
a second screen update register restricting an access from an OS other than a sub-OS that handles generation of a non-functional safety screen among the plurality of OSs, and storing second address information on an address of a second setting value list created by the sub-OS out of the setting value list, and
wherein the operation setting values of the first input unit, the second input unit, and the screen synthesis unit are rewritten in response to rewriting of at least one of the first address information and the second address information.

3. The semiconductor device according to claim 2,
wherein each of the first setting value list and the second setting value list has information on a size of its own list.

4. The semiconductor device according to claim 2, further comprising:
an activation control circuit issuing an access request to the setting value list based on address information stored in the first screen update register and the second screen update register in response to updating of any one of a value of the first screen update register, a value of the second screen update register, and a value of the attribute register; and
a memory access unit transmitting the operation setting values, which is related to a read OS identifier, to the first input unit, the second input unit, and the screen synthesis unit, the operation setting values being read in response to the access request, the read OS identifier indicating an OS that corresponds to a screen update register storing the address information contained in the access request,
wherein the mask circuit has a collation unit for collation about whether the read OS identifier matches the OS identifier corresponding to the own block out of the OS identifiers stored in the attribute register, and the collation unit allows rewriting of the operation setting value into the setting register group of the own block when the matching of the read OS identifier and the OS identifier is determined.

5. The semiconductor device according to claim 4, further comprising:
an occupation setting register storing, for each functional block, an occupation flag value indicating whether to use the value stored in the attribute register or a preset fixed value as the OS identifier to be given to the collation unit; and
a selector switching the OS identifier given to the collation unit between the value stored in the attribute register and the fixed value according to the occupation flag value.

6. The semiconductor device according to claim 5, further comprising:
a status register monitoring and holding the occupation flag value stored in the occupation setting register; and
an error register holding a value obtained by monitoring the occupation flag value, the read OS identifier input to the collation unit, and a register address designating a register included in the setting register group.

7. A semiconductor device comprising:
a plurality of functional blocks including a setting register group storing operation setting values, and operating according to the operation setting values; and
an attribute register storing an OS identifier indicating a type of OS having use authorities of the plurality of functional blocks for each functional block,
wherein the operation setting values are described in a setting value list created for each OS and stored in a shared memory shared by the plurality of OSs, and
wherein each of the plurality of functional blocks has a mask circuit that refers to the OS identifier of the attribute register and in which write of the operation setting values into the setting register group of its own block is hampered, the operation setting values being described in the setting value list created by an OS other than the OS having a use authority for the own block.

8. A hardware virtualization method of a semiconductor device including a plurality of functional blocks and a plurality of registers, the plurality of functional blocks including a setting register group that stores operation setting values, operating according to the operation setting values, and being shared by a plurality of OSs, the semiconductor device accessing a shared memory that includes a plurality of restricted regions restricting an access range for each of the plurality of OSs, the hardware virtualization method comprising:
setting an attribute register that stores, for each of the plurality of functional blocks, an OS identifier indicating a type of OS having use authorities of the plurality of functional blocks;
creating the operation setting value for each of the plurality of OS, and describing a setting value list stored in the shared memory; and
referring to the OS identifier of the attribute register, and hampering write of the operation setting values into the plurality of functional blocks of an own block, the operation setting value being described in the setting value list created by an OS other than the OS having a use authority for the own block.
